(19) United States
(12) Patent Application Publication
(10) Pub. No.: US 2006/0008722 A1
(43) Pub. Date: Jan. 12, 2006

(54) Use of wax-based compounds in toners and corresponding toners

(75) Inventors: Gerd Hohner, Sulzbach (DE); Michael Bayer, Thierhaupten (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant GmbH, Fankfurt Am Main (DE)

(21) Appl. No.: 10/532,774

(22) PCT Filed: Oct. 14, 2003
(86) PCT No.: PCT/EP03/11372

§ 371 Date: Apr. 22, 2005

(30) Foreign Application Priority Data
Oct. 22, 2002 (DE) 102 49 059.7

(51) Int. Cl. G03G 9/08

(52) U.S. Cl. 430/108.2; 430/137.1; 430/108.4; 430/108.8; 430/111.4

(57) ABSTRACT

The invention relates to the use of amide erucic compounds and one or several waxes in toners containing said compounds.

The present invention relates to the use of wax-containing combinations in toners and also toners in which such combinations are present.

In modern copying processes, it is usual to use toners comprising resins, pigments, charge control agents and waxes and also, if appropriate, flow aids. During copying, the pulverulent toners usually firstly reproduce the image to be copied on a transfer roller, are transferred from there to the copying paper and are subsequently thermally fixed.

The waxes present in the toner as formulation components act as release agents and anti-offset agents to aid detachment of the toner from the fixing roller, act as adhesion promoters on transfer to the paper and in the production of the toner act as dispersants and thus contribute to homogeneous distribution of the pigments.

The demand for ever faster copiers requires correspondingly fast-responding toner systems and places high demands on the individual components of the toner formulation.

The wax components used in toners have hitherto been predominantly hydrocarbon waxes such as polyethylene or polypropylene waxes. These waxes are not able to meet all the demands placed on them by modern fast-running copying machines. In particular, there is a need for wax components having an improved anti-offset action, improved performance in respect of adhesion of the print to the paper and further optimized pigment-dispersing properties.

JP-A-1 142 560 describes the use of erucamide in liquid toners. Owing to its low hardness, erucamide has only limited suitability for use in toners.

There has hitherto also been a shortage in the prior art of products having satisfactory release properties in toner resins without at the same time impairing the optical properties of the resin.

It is therefore an object of the present invention to provide a wax-containing combination which avoids the abovementioned disadvantages and can be used to give very good results in toners.

The invention therefore provides for the use of a combination of erucamide and one or more wax(es) in toners.

The wax is preferably selected from the group consisting of natural waxes and partially synthetic waxes.

The wax preferably has a needle penetration of not more than 10 mm⁻¹.

The wax preferably has a melting point of from 50 to 160° C.

The invention likewise provides toners comprising a combination of erucamide and one or more waxes.

The wax is in this case preferably selected from the group consisting of natural waxes and partially synthetic waxes.

The wax preferably has a needle penetration of not more than 10 mm⁻¹.

The wax preferably has a melting point of from 50 to 160° C.

For the present purposes, the term “wax” is used in accordance with a definition of the Deutschen Gesellschaft für Fettwissenschaft as a collective term for a series of materials of natural or synthetic (partially or fully synthetic) origin which have the following properties (Fette Seifen Anstrichmittel 76, page 135, 1974):
kneadable at 20° C.,
solid to hard and brittle,
coarsely to finely crystalline,
translucent to opaque, but not vitreous,
melts above 40° C. without decomposition,
relatively low viscosity even just above the melting point,
highly temperature-dependent consistency and solubility,
polishable under light pressure.

Possible natural waxes are, for example, plant waxes such as carnauba or candelilla wax or waxes of animal origin, e.g. shellac wax. Suitable partially synthetic waxes are, for example, bleached montan waxes which may have been chemically modified, e.g. by esterification and/or by partial saponification. Such products are described, for example, in Ullmann's Encyclopedia of Industrial Chemistry, 5th edition, Vol. A 28, Weinheim 1996, in chapters 2.2, 2.3 and 3.1-3.5.

It is also possible to use polar or nonpolar fully synthetic waxes, e.g. polyolefin waxes. Nonpolar polyolefin waxes can be prepared by thermal degradation of branched or unbranched polyolefins or by direct polymerization of olefins. Possible polymerization processes are, for example, free-radical processes in which the olefins, generally ethylene, are reacted at high pressures and temperatures to form more or less branched waxes; also processes in which ethylene and/or higher 1-olefins are polymerized with the aid of organometallic catalysts, for example Ziegler-Natta or metallocene catalysts, to form unbranched or branched waxes. Methods of these types for preparing olefin homopolymer and copolymer waxes are described, for example, in Ullmann's Encyclopedia of Industrial Chemistry, 5th edition, Vol. A 28, Weinheim 1996, in chapter 6.1.1./6.1.2. (high-pressure polymerization), chapter 6.1.2. (Ziegler-Natta polymerization, polymerization using metallocene catalysts) and chapter 6.1.4. (thermal degradation).

Polar polyolefin waxes are formed by appropriate modification of nonpolar waxes, e.g. by oxidation with air or by grafting-on of polar olefin monomers, for example α,β-unsaturated carboxylic acids and/or their derivatives, e.g. acrylic acid or maleic anhydride. Polar polyolefin waxes can also be prepared by copolymerization of ethylene with polar comonomers, for example vinyl acetate or acrylic acid; also by oxidative degradation of relatively high molecular weight ethylene homopolymers and copolymers which are not wax-like. Appropriate examples may be found, for example, in Ullmann's Encyclopedia of Industrial Chemistry, 5th edition, Volume A 28, Weinheim 1996, chapter 6.1.5.

Preference is given to the use of a combination of erucamide and waxes selected from the group consisting of natural and partially synthetic waxes.

The waxes used according to the invention have needle penetration values of not more than 10 mm⁻¹, preferably not more than 5 mm⁻¹, and dropping points of from 50 to 160° C., preferably from 60 to 120° C., particularly preferably from 70 to 90° C.

Base components present in toners are generally resins based on polyesters or styrene-acrylate copolymers. As charge control agents which aid the transfer of the toner from the photo roller to the paper substrate, use is made of, for example, quaternary ammonium salts for a positive charge and, for example, aluminum-azo complexes for a negative charge of the toner powder. To aid powder flow, small amounts of finely divided silicas can be added to the toner powder.

Depending on the desired color, suitable black or color pigments are added to the toners at the stage of the thermoplastic mixture.

### EXAMPLES

The needle penetration values reported below were determined in accordance with DIN 51579, and the dropping points were determined in accordance with DIN 51801/2.

### Examples 1 to 3

90 parts by weight of a styrene-acrylate resin (grade CPR 100, manufacturer: Mitsui; glass transition temperature: 60° C.; MFR/140° C.: 5 g/10 min) were homogeneously mixed with 4 parts by weight of a black pigment (carbon black having a mean particle size of 2 μm; manufacturer: Timcal), 1 part by weight of a charge control agent (®Copy Charge N4S, manufacturer: Clariant GmbH) and 4 parts by weight of an erucamide/wax combination used according to the invention as shown in Table 1 in a kneader. This mixture was then comminuted to give a toner powder having a mean particle size of 12 μm (100%<20 μm). 0.5 part by weight of a silica-based flow aid (grade HDK, manufacturer: Wacker) was then added to the toner powder. 5 g of this now free-flowing mixture were mixed with 95 g of iron powder and introduced into the reservoir of a copier.

Toner powder was then applied to a sheet of paper over an area of 20×100 mm by means of the photomagnetic roller in the copier. This image was then fixed by means of a roller arrangement comprising a rigid heatable roller and an elastic cold roller at 160° C. and a linear velocity of 150 mm/s. A further white sheet was subsequently passed through the hot pair of rollers and examined for toner residues. No “ghost pictures” were observed on the white sheet.

TABLE 1
Erucamide combinations used

| | | Weight ratio of |
|---|---|---|
| Example | Wax | erucamide:wax |
| 1 | ® Licowax E (Clariant GmbH) | 10:1 |
| | (NP: about 1, dropping point: | |
| | about 82° C.) | |
| 2 | ® Licowax F (Clariant GmbH) | 10:1 |
| | (NP: about 1, dropping points | |
| | about 79° C.) | |
| 3 | Carnauba wax (NP: about 1, | 10:1 |
| | dropping point: 83° C.) | |

1. A process for improving the release properties of a toner comprising the step of adding erucamide and at least one wax to the toner.

2. The process as claimed in claim 1, wherein the at least one wax is selected from the group consisting of natural waxes and partially synthetic waxes.

3. The process as claimed in claim 1, wherein the at least one wax has a needle penetration of not more than 10 mm⁻¹.

4. The process as claimed in one claim 1, wherein the at least one wax has a melting point of from 50 to 160° C.

5. A toner comprising erucamide and at least one wax.

6. The toner as claimed in claim 5, wherein the at least one wax is selected from the group consisting of natural waxes and partially synthetic waxes.

7. The toner as claimed in claim 5, wherein the at least one wax has a needle penetration of not more than 10 mm⁻¹.

8. The toner as claimed in claim 5, wherein the at least one wax has a melting point of from 50 to 160° C.

9. The process as claimed in claim 1, wherein the toner includes a toner powder and the adding step further comprises mixing the erucamide and the at least one wax with the toner powder.

10. A toner made in accordance with the process of claim 9.

11. A process of using a combination of erucamide and at least one wax as a release agent for a toner comprising the step of adding to combination of erucamide and at least one wax to the toner.

12. The process as claimed in claim 11, wherein the toner includes a toner powder and the adding step further comprises mixing the combination of erucamide and the at least one wax with the toner powder.

13. A toner made in accordance with the process of claim 11.

14. A toner made in accordance with the process of claim 12.
